(19) United States
(12) Patent Application Publication
(10) Pub. No.: US 2009/0308906 A1
(43) Pub. Date: Dec. 17, 2009

(54) Cap feeder with grip finger

(75) Inventor: Frederick W. Lamb, McCalla, AL (US)

Correspondence Address: Russell H. Walker;Walker, McKenzie & Walker, P.C., Suite 434, 6363 Poplar Avenue, Memphis, TN, 38119-4896, US

(73) Assignee: PneuTools, Incorporated, Memphis, TN (US)

(21) Appl. No.: 12/214,067

(22) Filed: Jun. 13, 2008

(51) Int. Cl. B27F 7/00

(52) U.S. Cl. 227/119

(57) ABSTRACT

A cap feeder for a fastener gun. The gun includes a footplate, a fastener magazine holding a supply of fasteners such as staples, a nose, an upright cap magazine for holding a stacked assembly of caps, a cap pusher mounted for reciprocation with respect to the footplate, and a pneumatic-powered driver for driving a fastener from the nose, through the cap while the cap is in a fastening position beneath the nose, and into a workpiece. The cap magazine is mounted proximate the nose. The cap feeder includes a reciprocator for moving the cap pusher. The cap feeder includes a grip finger mounted to the cap pusher and extending beyond a cap-engaging portion of the cap pusher. The grip finger extends under an edge of the cap and engages the underside of the cap. The reciprocator preferably includes a piston pneumatically coupled to a piston of the driver.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to powered staplers and fastener applicators, and in particular, to powered staplers and fastener applicators for inserting fasteners into fastener caps intended to be used as a washers for holding roofing paper, insulation wrap, and coverings to houses, lumber, and other articles in the construction industry.

2. Information Disclosure Statement

Well-known plastic fastener cap washers are often used to hold down roofing paper, insulation wrap, and coverings on houses, buildings, lumber, and other structures in the construction industry. Such well-known fastener caps, as might be used with the present invention, are disclosed, for example, in Lamb, U.S. Pat. No. 6,302,310 (issued Oct. 16, 2001), fully included herein by reference, and Lamb, U.S. Pat. No. 7,090,455 (issued Aug. 15, 2006), fully included herein by reference. Often, powered nail guns and staplers are used to drive staples and the like through the fastener caps, and such powered nail guns and staplers often have so-called well-known “magazine towers” for holding a stack of the fastener caps, as may be seen, for example, in the previously-mentioned reference Lamb, U.S. Pat. No. 7,090,455 (issued Aug. 15, 2006), which also discloses that the stack of fastener caps may be melted together around portions of their circumferences so as to form a unitary stack of caps that can be loaded and unloaded from the cap magazine tower. It is also known to have reciprocating slider plates to feed the bottommost cap from the stack of caps in a cap magazine tower, pushing the bottommost cap into position under the nail or stapler gun's nose so that a staple or nail may be driven through the cap and into a workpiece.

A problem with prior art cap feeders is that the reciprocating slider plates have a relatively long stroke so that the bottommost cap can be moved from the cap magazine tower to the nailing/stapling position under the nose of the gun. If the position of the staple gun is moved while the reciprocating slider plate is moving the bottommost cap into position for nailing or while a staple is being driven through the cap into the workpiece, the staple gun's driver blade will come off of the top of the driven staple (because the staple and cap will not move with the gun but will be anchored by the partially-driven staple into the workpiece), causing the staple not to be fully driven into the workpiece. It is therefore desirable to provide a reciprocating cap feeder plate that has a shorter reciprocation distance than heretofore known in the prior art, such that the cap is moved more quickly into position during the stapling operation than heretofore possible, thereby allowing less time for the gun to be moved during stapling.

It is also desirable that the operator of the nail or staple gun have unimpeded view of the workpiece, and prior art cap feeding mechanisms and towers have traditionally blocked the view of the workpiece by the operator, and the linkages that coordinate the operation of the cap feeder and its reciprocating slider plate are often complex. It is therefore desirable to have a cap feeder for feeding caps from a stacked assembly of caps in a magazine tower, whereby the cap feeder is compact, operates quickly and reliably with the magazine tower placed closely adjacent to the nose of the gun, and has a simpler design than heretofore known in the prior art.

### BRIEF SUMMARY OF THE INVENTION

The present invention is an improved cap feeder for a fastener gun. The cap feeder includes a reciprocating cap pusher having a cap-engaging portion that feeds a cap from a stacked assembly of caps into a fastening position beneath a nose of the gun, and a grip finger, mounted to the cap pusher and extending beyond the cap-engaging portion, grips and holds the underside of the cap being fed.

It is an object of the present invention to provide an improved cap feeder for feeding a cap from a stacked assembly of caps, in which the cap feeder is compact, operates quickly and reliably, and permits a cap magazine tower holding the stacked assembly of caps to be placed closely adjacent to the nose of the gun so that the cap being fed moves a shorter distance from the magazine to the nose of the gun than in the prior art. It is a further object of the present invention to permit the cap being fed from the cap magazine tower to be closer to the workpiece, while a fastener is being driven through the cap and into the workpiece, than permitted by prior art cap feeders.

### BRIEF DESCRIPTION OF THE SEVERAL VIEWS OF THE DRAWING

FIG. 1 is a left side view of the cap feeder of the present invention as a part of a fastener gun above a workpiece, showing in dotted outline the movement of a safety linkage when the gun rests on the workpiece.

FIG. 2 is a right side view of the cap feeder of the present invention as a part of the fastener gun, showing the gun resting on the workpiece.

FIG. 3 is an underside view of the footplate of the present invention, showing in dotted outline the movement of a cap by the reciprocating cap pusher as the cap is gripped by the grip finger while the cap is moved into a fastening position beneath the nose of the fastener gun.

FIG. 4 is another underside view of the footplate of the present invention, showing the cap pusher in a first position as the grip finger grabs the bottommost cap in the cap magazine tower.

FIG. 5 is a side elevation partial sectional view showing gripping of the cap by the grip finger.

FIG. 6 is a front elevation view of the fastener gun with the cap feeder of the present invention.

FIG. 7 is a top plan view of a prior art cap fastener with a staple therethrough.

FIG. 8 is a side sectional view of a prior art cap fastener.

FIG. 9 is a side sectional view of a prior art cap fastener with a staple therethrough into a workpiece.

FIG. 10 is a front elevation partial sectional view of the cap feeder of the present invention with some portions removed for clarity, showing the cap pusher in the second position with a cap in the fastening position beneath the nose.

FIG. 11 is a front elevation partial sectional view of the cap feeder of the present invention, similar to FIG. 10 and also with some portions removed for clarity, showing the cap pusher in the first position and engaging the bottommost cap of the stack of caps in the cap magazine tower.

FIG. 12 is a top plan view of the cap feeder and the reciprocator, with the cap pusher in the first position and showing the linkage between the reciprocator and the cap pusher, with a cap being shown in dotted outline.

FIG. 13 is a schematic diagram showing the pneumatic coupling between the first and second pistons and their joint movement as the trigger valve is operated.

### DETAILED DESCRIPTION OF THE INVENTION

Referring to the drawing figures, the present invention is an improved cap feeder for a fastener gun 22. Except for modifications to the fastener gun 22 as hereinafter described to accommodate the improved cap feeder 20, fastener gun 22 is well-known to those skilled in the art. Fastener gun 22 has a well-known fastener magazine 24 holding a supply of well-known fasteners such as staples 26. Fastener gun 22 is used in a manner well-known in the prior art to insert fasteners, such as staples 26, through well-known plastic fastener caps 28 and into a workpiece 30, as best seen in FIGS. 7, 8, and 9, enabling the caps 28 to be used as washers in a manner well-known in the prior art to hold sheets 32, such as roofing paper, insulation wrap, and coverings, against the workpiece 30.

Fastener gun 22 includes a well-known upright cap magazine tower 34 for holding a stacked assembly 36 of caps 28, and caps 28 may preferably be melted together at circumferential portions as disclosed in Lamb, U.S. Pat. No. 7,090,455 (issued Aug. 15, 2006), fully included herein by reference. Fastener gun 22 includes a nose 38 and a pneumatic-powered driver 39 for driving a fastener 26 from the nose, through a cap 28 when the cap is in a fastening position beneath the nose 38, and into workpiece 30.

Fastener gun 22 also includes a footplate 40 that rests against the workpiece 30. While prior art fastener guns 22 are known to have footplates that rest against a workpiece, the footplate 40 of the present invention is modified from the prior art and is adapted for use with the cap pusher and grip finger of the present invention, as hereinafter described in detail.

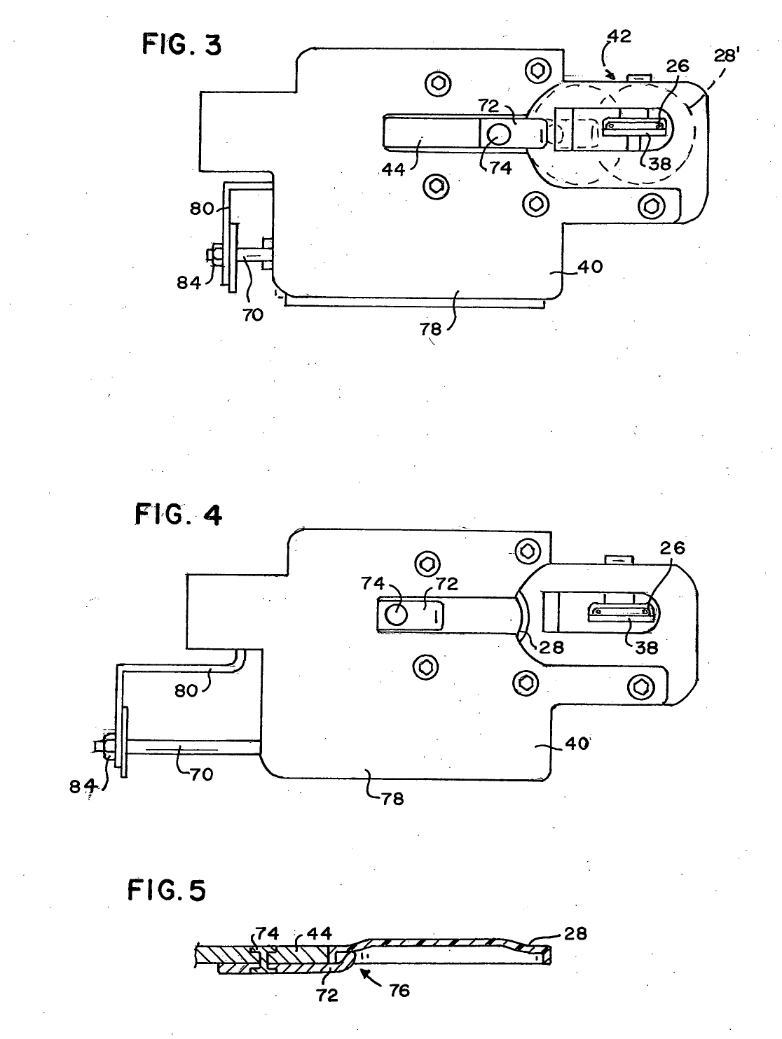

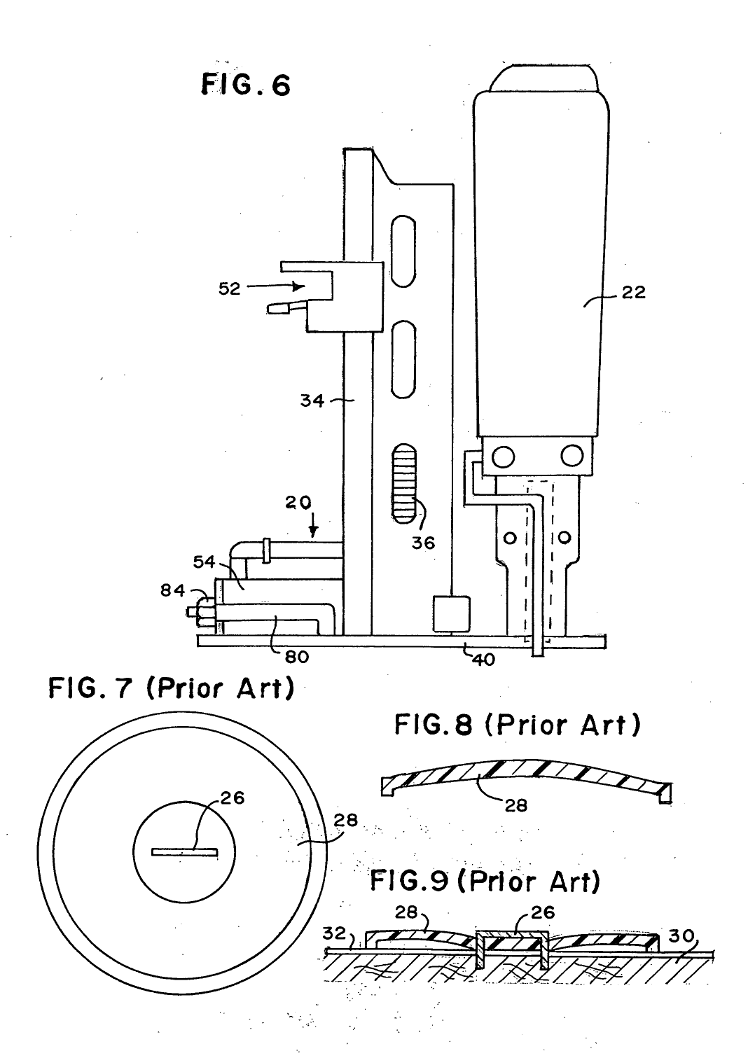

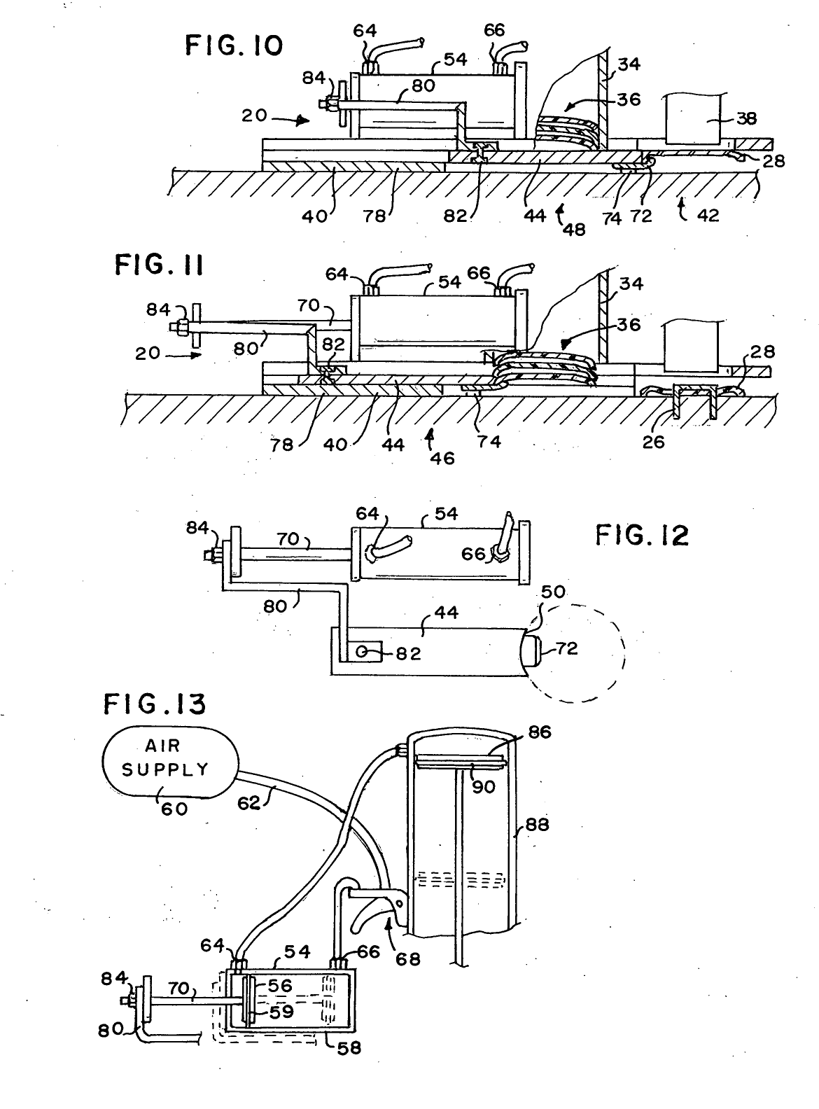

The improved cap feeder 20 of the present invention is for sequentially feeding the bottommost cap from the stacked assembly of caps into a fastening position 42 as shown in FIG. 10 (see also cap 28′ shown in dotted outline in FIG. 3) beneath the nose 38.

Cap feeder 20 of the present invention includes a cap pusher 44 mounted for reciprocation with respect to footplate 40, moving from a first position 46 shown in FIG. 11 to a second position 48 shown in FIG. 10. Cap pusher 44 has a preferably concave cap-engaging portion 50 on its leading edge for mating with and engaging a portion of the circumference of the bottommost cap 28. As cap pusher 44 reciprocates with respect to footplate 40 from first position 46 to second position 48 while engaging cap 28 with cap-engaging portion 50, cap 28 is fed from the bottom of the stacked assembly 36 of caps in cap magazine tower 34 to fastening position 42 beneath the nose 38. Upright cap magazine tower 34 preferably has a well-known cap urger 52 mounted for vertical reciprocation thereupon, and cap urger 52 is spring biased toward the bottom of magazine tower 34 in a manner well-known to those skilled in the art so as to urge the stacked assembly of caps downward toward the workpiece, enabling the bottommost cap to be sequentially fed from the cap magazine tower 34.

In an improvement over the prior art, the cap magazine tower 34 is mounted proximate the nose 38 so that the movement of caps 28 from the stacked assembly of caps 36 to fastening position 42 is a very short distance. The close mounting of the cap magazine tower to the nose 38 is possible because of the structure of the improved cap feeder 20 of the present invention, as will now be explained in detail.

Cap feeder 20 includes a reciprocator 54, preferably a well-known pneumatic first reciprocating piston 56 mounted within a cylinder 58 (see FIG. 13) and preferably sealed to the interior of cylinder 58 as by a well-known O-ring 59 such that, when air pressure is supplied from an air supply 60 through a supply hose 62 and alternately to air ports 64, 66 of reciprocator 54, as by actuation of a well-known trigger valve 68, piston 56 of reciprocator 54 will cause rod 70 to extend from cylinder 58 (as air is forced into port 66 and air is bled from port 64) as shown in solid outline in FIG. 13 or to retract into cylinder 58 (as air is forced into port 64 and bled from port 66) as shown in dotted outline in FIG. 13.

The improved cap feeder 20, in a significant improvement over the prior art, includes a grip finger 72 mounted to cap pusher 44 as by welding or preferably by a rivet 74 into cap pusher 44, with grip finger 72 extending from the leading portion of cap pusher 44 beyond the cap-engaging portion 50 of cap pusher 44 so that, when the cap-engaging portion is engaging the bottommost cap 28 of the stacked assembly 36 of caps, the grip finger extends under the bottom edge of the cap 28 and engages the underside 76 of cap 28 as best seen in FIG. 5 and FIGS. 3, 4, 10, and 11. Grip finger 72 is preferably thin and made of resilient spring steel. Because grip finger 72 is thin, the bottom plate 78 of footplate 40 of can be thinner than heretofore possible in the prior art, thereby requiring cap 28 to move a shorter distance vertically to the outer surface of workpiece 30 while in the fastening position, thereby reducing the opportunity for movement of the nose 38 of gun 22 by the operator during the driving of the fastener 26 through the cap 28 into the workpiece. In prior art stapling guns, if the nose of the gun moves even slightly during stapling, the driver blade will come off of the top of the staple 26, thereby causing the staple to not be fully driven into the workpiece. With the present invention, because the cap is closer to the workpiece during the stapling process as the driver blade impacts the staple, there is less opportunity for movement of the driver blade off of the staple. While the preferred embodiment of the present invention uses only a single grip finger 72, it should be understood that a plurality of grip fingers may be provided, each attached to cap pusher 44 and spaced apart around the trailing perimeter of the cap 28, each engaging the underside of the cap. The resilience of grip finger 72, being made from thin spring steel, combined with the slight flexibility of the plastic caps 28, allows the cap pusher 44, when retracting back into the first position after the cap 28 has been fastened to the workpiece, to pull the grip finger 72 over the underside edge of the fastened cap 28 and out from under the underside 76 of cap 28. When the cap-engaging portion 50 of cap pusher 44 passes by the stacked assembly 36 of caps in the cap magazine 34 during reciprocation of cap pusher 44 from second position 48 shown in FIG. 10 to first position 46 shown in FIG. 11, the bottommost cap 28 drops downward, under urging of cap urger 52, and then becomes engaged on its underside by grip finger 72 so that the cap pusher 44 can feed that next cap 28 into the fastening position when reciprocated by the reciprocator 54.

Cap pusher 52 is coupled to first reciprocating piston 70 of reciprocator 54 by a linkage 78, preferably rigid and a unitary piece of metal, that is preferably fixedly joined to cap pusher 52 as by welding or a rivet 82 and fixedly joined to piston rod 70 as by a nut 84 threaded onto the distal end of piston rod 70. Cap pusher 44 is preferably mounted to footplate 40, for reciprocation with respect to footplate 40, by a pair of longitudinally-entrapping lips 85 (best seen in FIG. 2).

In the preferred embodiment of the present invention, the well-known pneumatic-powered driver 39 of the fastener gun 22 includes a second reciprocating piston 86 mounted for reciprocation within a cylinder 88 of driver 39 and sealed to cylinder 88 by a well-known O-ring 90. It is well-known to have trigger valve 68 supply air above piston 86 to cause the driver 39 to impact a leading fastener 26 from the supply of fasteners in the fastener magazine and to cause the fastener to be driven through the cap 28 and the workpiece as heretofore described. As trigger valve 68 is actuated by the operator, the air is bled from below second piston 86 and is applied above second piston 86 so as to cause the driver to impact the fastener 26. In the improvement of the present invention, port 64 of reciprocator 54 is pneumatically coupled by an air line 92 to a port 94 that is in communication with the chamber above second piston 86, such that, when pressurized air is supplied to second piston 86 by trigger valve 68, pressurized air is simultaneously applied to port 64 of reciprocator 54 at the same time that trigger valve 68 bleeds air from port 66 of reciprocator 54, causing first piston 56 to move the cap pusher 44 from its first position to its second position in tandem with the movement of the driver piston 86 toward the fastener 26. While piston 56 and/or piston 86 could be spring biased back into their original positions when the trigger valve 68 is released by the operator, in the preferred embodiment the trigger valve, when released, will bleed air from the chamber above piston 86 while also supplying pressurized air to port 66, causing reciprocator piston 56 to quickly retract to its original position (bringing cap pusher 44 back to the first position) and allowing piston 86 to retractingly rise.

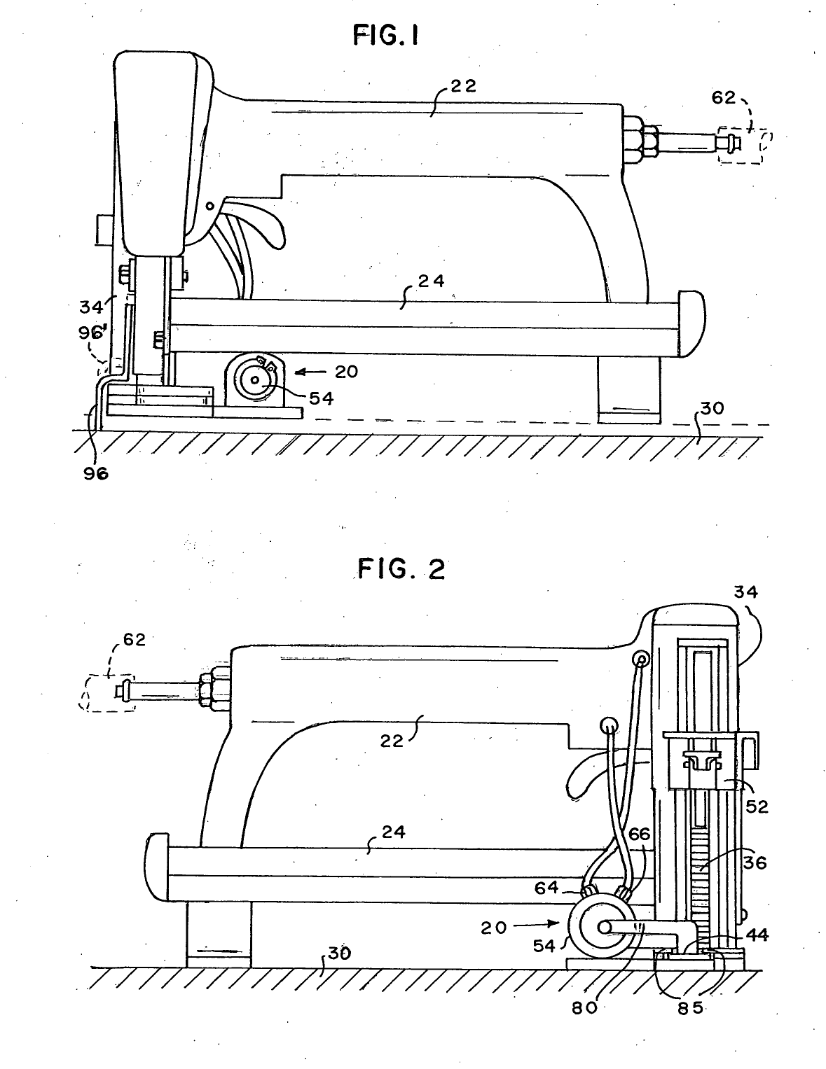

Preferably, for safety and protection of the operator, a well-known safety interlock linkage 96, coupled to trigger valve 68, extends below the footplate 40 for engagement with the workpiece (as best seen in FIG. 1) so that, when the fastener gun 22 is placed upon the workpiece, the interlock linkage 96 is moved by the workpiece to a postion 96′ shown in dotted outline in FIG. 1, thereby allowing trigger valve 68 to be actuated by the operator. When the safety linkage 96 is not in the moved position 96′, as is the case when the fastener gun is not engaged with the workpiece, the trigger valve 68 cannot be actuated.

Although the present invention has been described and illustrated with respect to a preferred embodiment and a preferred use therefor, it is not to be so limited since modifications and changes can be made therein which are within the full intended scope of the invention.

I claim:

1. An improved cap feeder for a fastener gun, said fastener gun having:
(a) a footplate;
(b) a fastener magazine holding a supply of fasteners;
(c) a nose;
(d) an upright cap magazine for holding a stacked assembly of caps; said cap feeder being for feeding a cap from said stacked assembly of caps to a fastening position beneath said nose; and
(e) a pneumatic-powered driver for driving a fastener of said supply of fasteners from said nose, through said cap in said fastening position, and into a workpiece;
said cap feeder including a cap pusher mounted for reciprocation with respect to said footplate from a first position to a second position, said cap pusher having a cap-engaging portion for feeding said cap from said stacked assembly of caps to said fastening position beneath said nose;
wherein the improvement comprises said cap magazine being mounted proximate said nose; said cap feeder including: a reciprocator for moving said cap pusher from said first position to said second position; and a grip finger mounted to said cap pusher and extending beyond said cap-engaging portion so that, when said cap-engaging portion is engaging said cap from said stacked assembly of caps, said grip finger extends under an edge of said cap and engages the underside of said cap.

2. The improved cap feeder as recited in claim 1, in which said reciprocator includes a first reciprocating piston; said cap pusher being coupled to said first reciprocating piston for joint movement therewith; said pneumatic-powered driver having a second reciprocating piston; said first reciprocating piston being pneumatically coupled to said second reciprocating piston so that, when a source of air is applied to said second reciprocating piston to cause said pneumatic-powered driver to impact said fastener from said supply of fasteners, said pneumatic coupling causes said first reciprocating piston to move said cap pusher from said first position to said second position.
